(19) United States
(12) Patent Application Publication
(10) Pub. No.: US 2004/0231862 A1
(43) Pub. Date: Nov. 25, 2004

(54) Corrosion monitoring station

(76) Inventors: Michael D. Kirn, Chesterfield, MO (US); Mlchael F. Cabral, Wildwood, MO (US)

Correspondence Address: LEWIS, RICE & FINGERSH, LC, ATTN: BOX IP DEPT., 500 NORTH BROADWAY, SUITE 2000, ST LOUIS, MO, 63102, US

(21) Appl. No.: 10/851,260

(22) Filed: May 21, 2004

Related U.S. Application Data
(60) Provisional application No. 60/472,535, filed on May 22, 2003.

(51) Int. Cl. A62C 35/00

(52) U.S. Cl. 169/16; 169/17

(57) ABSTRACT

A corrosion monitoring station for a water-based fire protection system which allows for test coupons to be removed without having to drain the system. The corrosion monitoring station also generally provides for mimicking of the conditions present in at least a portion of the water-based fire protection system and can provide for a portion of the system which can be easily removed for more extensive testing.

### CROSS REFERENCE TO RELATED APPLICATION(S)

This application claims priority to U.S. Provisional Application Ser. No. 60/472,535, filed May 22, 2003, the entire disclosure of which is herein incorporated by reference.

### BACKGROUND OF THE INVENTION

1. Field of the Invention

The present invention pertains to a device for monitoring corrosion and microbial activity in a piping system, particularly to a mounting and coupon rack for monitoring corrosion and microbial activity in a fire protection system.

2. Background of the Invention

To fight fires in modern buildings, firefighters use a wide variety of tools but are also regularly aided by systems within the building. Modern buildings almost universally include water-based fire protection systems to control or extinguish fires. One type of fire protection systems are fire sprinkler systems which generally follow a fairly standardized principle. A liquid firefighting material (generally water) is maintained in a series of pipes, generally under pressure, which are arranged throughout all areas of the building. Attached to these pipes are various sprinklers which, when activated, will spray the liquid into a predetermined area. When a fire situation is detected, sprinklers on the pipe structure are activated by heat which then spray water. This activation is generally performed by a heat sensitive element, an integral part of the sprinkler, which is activated by the heat from the fire. Generally, each sprinkler with its own heat sensitive element is activated independent of all other sprinklers. When a particular sprinkler is activated, the liquid in the pipes is dispensed by the sprinkler to a predetermined location. This action dispenses the liquid on the fire and serves to control or extinguish the fire.

The most common liquid used in fire protection systems is water because it is readily available, non-toxic, and quite effective in firefighting. The water used, however, is generally not pure and can contain a multitude of dissolved solids, water treatment chemicals and microorganisms. These impurities can contribute to corrosion and microbial activity damaging to pipes or other components that make up the water-based fire protection system. The presence of trapped air (particularly oxygen) and how active a system is (how often it is drained and filled) will also contribute significantly to corrosion and its damaging effects.

The slow degradation of components of water-based fire protection systems and/or deposition of materials within these systems will result in their eventual failure. In particular, the pipes may fail leading to an unintended release of liquid which can be disastrous. This failure can lead to the discharge of water which can damage the building, building infrastructure, or objects in the building (such as computer equipment). Even if the integrity of the pipes is maintained, the water-based fire protection system could fail by having a buildup of either products of corrosion or biomass which leads to the water-based fire protection system being unable to respond as intended in the event of a fire.

In an exemplary situation, a buildup of products of corrosion or biomass in the pipe could lead to insufficient flow or blockage at a sprinkler or blockage of a pipe resulting in an insufficient discharge of water where it is needed. This situation can result in failure of the water-based fire protection system to do its job effectively. In the most extreme situations, the system could completely fail to meet its intended function in the event of a fire due to products of corrosion and/or biomass buildup.

Generally, examination of a water-based fire protection system's pipes for conditions which could eventually lead to failure could only occur when the system was drained or out of service. Visual inspection generally requires an empty pipe for service personnel to make visual observations. Further, other types of monitoring devices would require an access point into the water-based fire protection system which could not be opened to examine when the system was full of liquid as the liquid would escape. This can be particularly problematic when the liquid is maintained under pressure as is the case for wet pipe water-based fire protection systems.

While remote sensors which can operate to provide information to a remote location while the wet pipe water-based fire protection system is full of liquid can be used to provide for indications of some conditions inside the pipe, many of the best tests require the removal of something which was within the pipe from the pipe to determine the status of the pipe. Often times, these items are referred to as “test coupons” and could be small patches or panels of particular materials which may express certain properties when exposed to various conditions or may be constructed of materials used in the system to directly show that material's degradation or accumulated microbial activity. Alternatively, test coupons may be panels of different materials to show how those types of materials degrade, corrode or acquire deposits inside the pipe even if such materials are not used in the water-based fire protection system.

A test coupon could be manufactured of a material of which a portion of the water-based fire protection system was constructed to determine the current state of degradation of that particular material, which may not otherwise be able to be inspected. To determine if the wet pipe water-based fire protection system is still functional and not overly corroded or suffering from undue buildup, the test coupon is exposed to the same conditions as a wet pipe water-based fire protection system by being placed in the system. When the system is drained, the coupon is removed and the degradation or buildup can be directly observed and/or evaluated by a laboratory. The test coupon is then generally replaced by a similar test coupon prior to the liquid being returned. Once a certain level of corrosion or buildup is detected, corrective measures may be introduced or maintenance may be performed to keep the wet pipe water-based fire protection system functional.

The test coupon need not necessarily be a material used in the system. Other materials can be used which happened to react to indicate particular properties. For instance, corrosion may occur at a higher rate with the material in the test coupon compared with the material in the pipe. Therefore, the corrosion mechanism can be detected faster and neutralized before it causes any damage to the water-based fire protection system. These types of coupons do not directly show what is happening in the pipe, but can serve as more sensitive warning indicators that a problem may be occurring in the future and preemptive correctional measures can be taken.

Coupon-style testing methods have generally only allowed readings to be taken when the system is drained as it is the only way to remove the test coupon. The problem with this examination pattern is that it is necessarily imperfect as it cannot measure corrosion or microbial activity or other status in the system while the system is functioning. In particular, the quantity of impurities can change between the different fills of water used in the wet pipe water-based fire protection system simply due to fluctuations in the quality of available water on different days. For instance, a first fill may have a first impurity level, while the second fill may have a second level of that same impurity which is less than the first. These could be, for instance, because a public water system being used to fill the wet pipe water-based fire protection system was cleaned between the filling activities or a filter for the water was routinely changed after the first fill and before the second. Further, drain and fill operations require the system to be taken out of service so they necessarily present an undesirable time period where the fire protection system is non-functional.

There are some systems which do not require drainage for coupons, but these generally suffer other problems. In particular, they are often complicated to use and manufacture as they usually utilize more expensive sensors for monitoring and require transmission networks to communicate their findings. Further, the systems generally do not allow internal inspection of the pipe even though they may provide indications of a particular occurrence in the pipe. As an internal inspection is often more telling than the result of any analysis device, this is a serious disadvantage. Such systems also are not always duplicative of conditions inside the rest of the pipe of interest and the systems may not correctly analyze the liquid/gas interface, or may not even have access to an interface even if one is present elsewhere in the system.

### SUMMARY

Because of these and other problems in the art, described herein is a corrosion monitoring station which allows for test coupons, sprinklers or electronic probes to be removed from a water-based fire protection system without having to drain the system. Such a system therefore generally allows for test coupons, sprinklers or electronic probes to be used to evaluate corrosion and microbial activity inside the pipe and employ counter-measures based on that evaluation.

Described herein, in an embodiment, is a corrosion monitoring station for a water-based fire protection system comprising: a first section of pipe, the first section replacing a portion of a water-based fire protection system and being constructed of substantially similar material to the portion it replaces; a second section of pipe, the second section being constructed of a substantially similar material to the first section; a first flow pipe including a first valve, the first flow pipe allowing liquid to flow from the first section to the second section when the first valve is open, and prohibiting liquid from flowing between the sections when the first valve is closed; and a series of coupons mounted within the second section; wherein the coupons can be removed for testing without draining the water-based fire protection system by closing the first valve, draining the second section, and removing the coupons.

In an embodiment of the corrosion monitoring station the first section and the second section are constructed of identical materials.

In an embodiment of the corrosion monitoring station there is further included: a second flow pipe including a second valve, the second flow pipe allowing gas to flow from the first section to the second section when the second valve is open, and prohibiting gas from flowing between the sections when the valve is closed; wherein when the coupons are removed for testing, the second valve is also closed. In an embodiment, when the first valve and the second valve are both open, the levels of liquid and gas in the first section and the second section are substantially the same, the first flow pipe is connected to the lowest point of the first section and the second section and the second flow pipe is connected to the highest point of the first section and the second section, or the first and the second flow pipes are both generally in the plane of the second section of pipe.

In an embodiment of the corrosion monitoring station both the first section of pipe and the second section of pipe may be arranged in generally the same horizontal plane and the portion of the water-based fire protection system replaced by the first section may comprise a portion of a main or a branch line.

In an embodiment of the corrosion monitoring station the first section may also include a series of coupons therein or two couplings for removably attaching the first section to the water-based fire protection system. The second section may also includes similar couplings to the first section.

In an embodiment of the corrosion monitoring station at least one of the first section and the second section may include a sprinkler or an electronic probe. In an embodiment, the water-based fire protection system may comprise either a wet pipe water-based fire protection system or a dry pipe water-based fire protection system.

### BRIEF DESCRIPTION OF THE DRAWINGS

FIG. 1 shows a top down view of an embodiment of a corrosion monitoring station installed in a main of a water-based fire protection system.

FIG. 2 shows a end on view of the corrosion monitoring station of FIG. 1 along the line 2-2 showing the preferred horizontal placement with the end caps of the coupon rack removed and the coupon rack drained.

FIG. 3 shows a side view of the embodiment of FIG. 1 along the line 3-3 with the main in the distance.

FIG. 4 shows a top down view of another embodiment of a corrosion monitoring station installed in a main of a water-based fire protection system.

FIG. 5 shows a cut-through drawing of the corrosion monitoring station of FIG. 4 along the line 5-5 showing the preferred horizontal placement.

### DESCRIPTION OF PREFERRED EMBODIMENT(S)

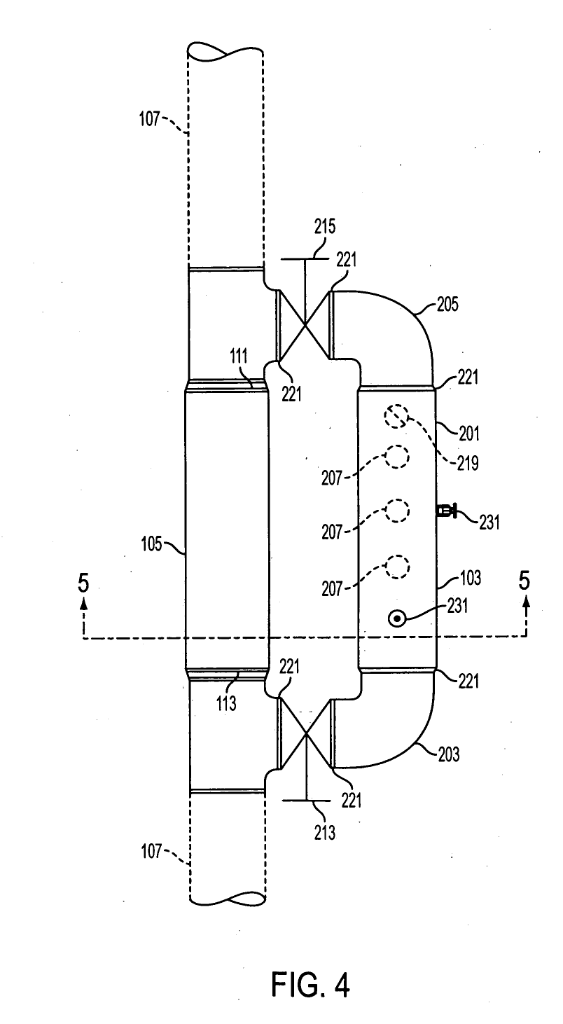

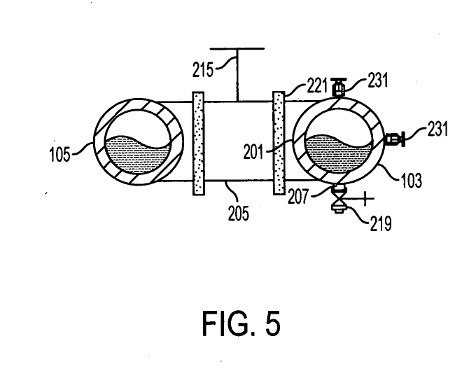

In order to allow for monitoring of the conditions inside a water-based fire protection system without having to drain the system and to improve corrosion monitoring generally, there are described herein embodiments of a corrosion monitoring station (100) for use in a water-based fire protection system. Embodiments of the corrosion monitoring station (100) may be used in any type of water-based fire protection system including, but not limited to, those commonly referred to as dry pipe and wet pipe systems. The embodiments depicted herein are principally shown in use in a wet pipe system where water is purposefully stored in the pipe being monitored. The embodiments could be used in a dry pipe system in a similar way, particularly the embodiment of FIGS. 4 and 5. In a dry pipe system, while water is not purposefully stored in the dry pipe region, water will often be present in the pipe such as from imperfect drainage of water or from condensation from the air and the station can monitor the corrosive or other effect of this water in these types of systems.

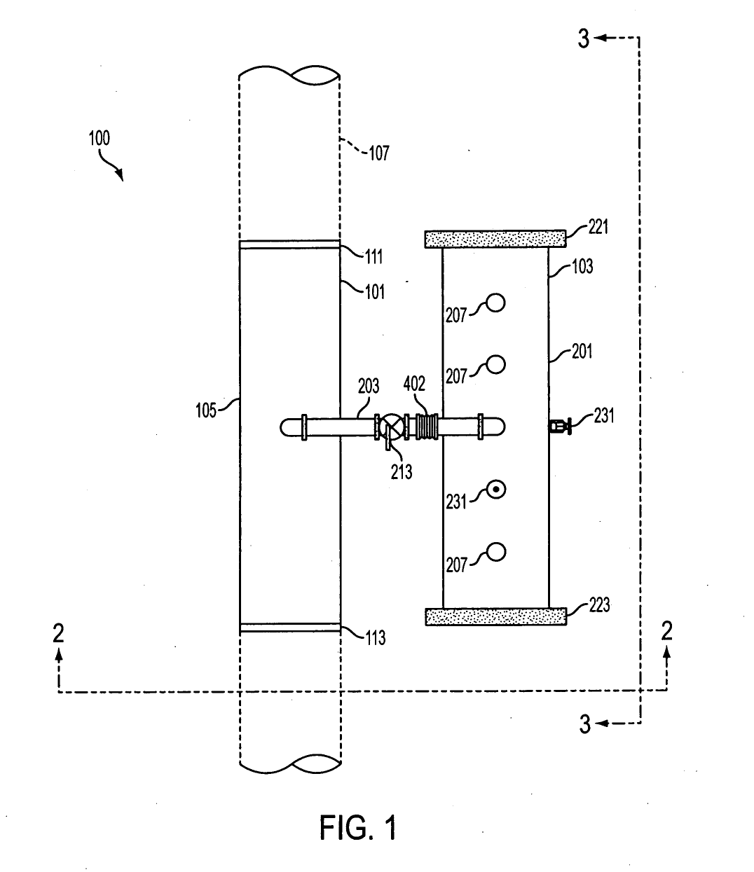

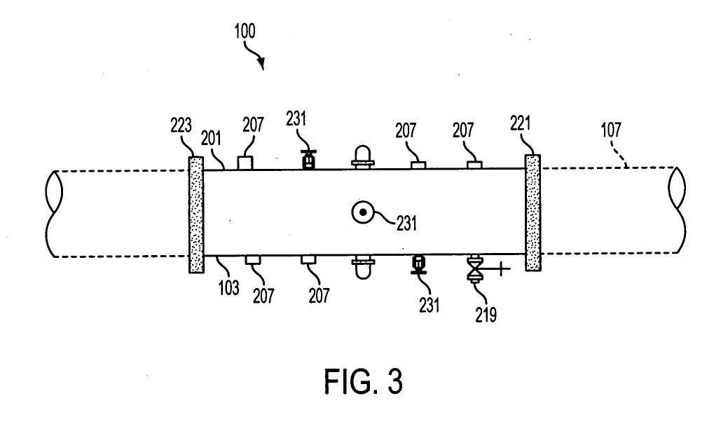

FIGS. 1 through 3 disclose a corrosion monitoring station (100) generally for use with a wet pipe water-based fire protection system or similar piped system at least partially filled with a liquid; however, the corrosion monitoring station (100) may be used in a dry pipe or other water-based fire protection system and for purposes of this disclosure the system will be generally referred to as a water-based fire protection system of any type even though a wet pipe system is depicted. The corrosion monitoring station (100) of an embodiment is partially a component which becomes a part of the water-based fire protection system, and partially is an externally isolable component which is designed to mimic conditions inside the system. The corrosion monitoring station (100) also allows for a portion of the water-based fire protection system to be easily removed and replaced for easier and/or more extensive testing and evaluation if desired.

The corrosion monitoring station (100) comprises two general components. The first component is a test spool (101) while the second component is a coupon rack (103). These two components are interconnected with each other via at least one flow pipe (203) or (205). In an embodiment, the test spool portion (101) of the corrosion monitoring station (100) effectively becomes a part of the water-based fire protection system while the coupon rack (201), while attached thereto and in fluid communication therewith, can be isolated from or combined with the system, depending on control exercised by maintenance personnel.

In particular, the corrosion monitoring station (100) would generally be installed in the system where the greatest corrosion and/or microbial activity is anticipated. Further, the interior of a main (107) or branch line is one place where it is desirable to examine the interior of the wet pipe water-based fire protection system for corrosion or microbial activity. For the purpose of this disclosure, it will be presumed that the depicted corrosion monitoring station (100) is attached to a main (107) although one of ordinary skill in the art would understand how to design and attach the corrosion monitoring station (100) to a branch line or any other pipe in the water-based fire protection system based on the below disclosure.

In particular, in another embodiment, the corrosion monitoring station (100) may be sized and configured to represent a section of branch line and may be attached to an existing section of branch line in the same way the below embodiment is attached to a main (107). In such an embodiment, the corrosion monitoring station (100) may include other components of a branch line such as a sprinkler, as discussed below.

The test spool (101) comprises a first section of pipe (105) or other hollow object which is designed to be included as a section of the pipe to which it is attached, the main (107) in the depicted embodiment, when the system is used and two connectors (111) and (113). The main (107) is simply a pipe in the water-based fire protection system. In construction (or later, during retrofitting) of the water-based fire protection system, a section of the main (107) may be removed or left missing. On the ends of the main (107) bordering this section, there may then be attached connectors designed to mate with connectors (111) and (113).

Prior to filling the system with liquid or bringing it into service, the test spool (101) replaces this missing section by connecting with the main (107) at connectors (111) and (113). Once connected, the main (107) and test spool (101) together form a complete and watertight main (107). In effect, the first section of pipe (105) is actually a part of the main (107), but is segregated from a traditional main (107) (pipe) construction by being connected by connectors (111) and (113).

While the above embodiment presumes that the connectors (111) and (113) are a part of the test spool (101), the connectors (111) and (113) may actually be a part of the main (107) or may be separable from both components. In particular, the connectors (111) and (113) may be any type of connector for connecting pipe as is known to those of ordinary skill in the art. This includes, screw-type connectors, clamps, or any other type of connector. In a preferred embodiment, connectors (111) and (113) comprise grooved couplings. In still another embodiment, the point of connection can also include a valve or similar device which could allow any fluid in the main (107) but not in the test spool (101), to be segregated from the test spool (101) or maintained in the main (107) if the test spool (101) is removed.

It is further preferred that the first section (105) be manufactured of piping which is substantially similar, or even more preferably the same, to the piping which is used to manufacture the main (107). In particular, this will generally result in the test spool being of similar cross-sectional size to the main (107) and being constructed of similar materials, and using similar techniques to the main (107). In this way, the test spool (101) essentially becomes a representative section of main (107) which is readily removed from the main (107) and returned or replaced. In a preferred embodiment, the first section (105) is actually the removed portion of the main (107) reattached with connectors (111) and (113).

When the test spool (101) is removed from the main (107), the interior of the main (107) can be directly viewed by maintenance personnel to search for damage or corrosion by them viewing through the points where connectors (111) and/or (113) connect to the main (107). Further, the interior of the first section (105) can also be viewed. As the first section (105) is preferably of similar construction to the main (107), the first section (105) can be considered as a representative sample of main (107) but can generally allow for preferential viewing. In particular, the first section (105) will generally be of significantly less length than the main (107). Therefore when it is removed, more light can be provided into the section (105) and returned to a viewer than in the main (107). Further, the first section (105) is generally portable from the site for examination at a remote location.

So as to provide for easy removal and replacement of the first section (105), it is preferable that the distance between the connectors (111) and (113) be of a predetermined and fixed length across multiple installations. It is further preferable that the first section (105) be sized to fit and attach in a location with this spacing and be of manageable size to be removed by hand. In an embodiment, first section (105) is around 2 ft in length although one of ordinary skill in the art would understand that longer or shorter lengths could alternatively or additionally be used.

It is preferred that the first section (105) be attachable through the use of connectors (111) and (113) which allow for the section to be quickly and easily removed. It is further preferred that the connectors (111) and (113) allow for the test spool (101) to be removed, and then replaced with a similar test spool (101) which can be produced to known size requirements prior to the removal of the present test spool (101). In this way, a test spool (101) can be removed, and another test spool (101) can be returned in its place allowing the water-based fire protection system to be in use while the first test spool (101) is being examined. This is particularly valuable if the test spool (101) requires extensive or destructive testing, as the water-based fire protection system does not need to be left out of service while the test spool (101) is being tested. This can allow for tests to be performed on the test spool (101) which could not be performed on the rest of the main (107). In particular, these tests may have to be performed at a remote location, or may be destructive to the first section (105).

While the test spool (101) provides for improved testing of the main (107), removal of the test spool (101) for testing still requires removal of a portion of the main (107) in order to test and therefore testing generally requires draining of the water-based fire protection system. The second component of the corrosion monitoring system (100) generally allows for testing without drainage of the water-based fire protection system.

This second component is generically referred to as the coupon rack (103). The coupon rack (103) preferably comprises a second section (201) of pipe which includes numerous attachment or access points (207). These access points (207) are essentially connectors whereby an object can be placed into or removed from second section (201). In particular, the access points allow for the placement of test coupons or other sensors within the second section (201) which can later be removed and replaced with other test coupons or sensors. This second section (201) is preferably substantially similar to, or more preferably the same as, the first section (105) in manufacture and materials therefore making it similar to, or the same as, the construction of the main (107). In an embodiment, the second section (201) and first section (105) are substantially interchangeable and may actually be interchangeable with the second section (201) being able to be attached by connectors such as connectors (111) and (113).

The coupon rack (103) is preferably designed to essentially be a section of main (107), which can be separated from the main by manipulation of the flow pipes (203) and (205), without having to drain the main (107). As the main (107) generally runs essentially horizontally, it is preferable that the first section (105) and second section (201) be arranged to be generally parallel in configuration and in the same or similar horizontal plane when the test spool (101) is installed in the main (107). In this way any gravitational effects present on the main (107) are substantially duplicated in the coupon rack (103). It is further preferred that the second section (201) have a predetermined length which is generally significantly less than the length of the main (107), and may or may not be the same length as the first section (105). In one embodiment, the second section (201) is chosen to be about 2 feet in length. In this way, the second section (201) is of sufficient length to allow the mounting of coupons, while still being sufficiently small to be easily removed and transported by hand. Further, it is generally preferred that the internal volume of the coupon rack (103) be much less than the internal volume of the main (107). If this is the case, changes introduced into the water-based fire protection system by changes within the coupon rack (103), are generally not that significant when spread over the entire water-based fire protection system. The reasons for this particular design will become clear later in this disclosure.

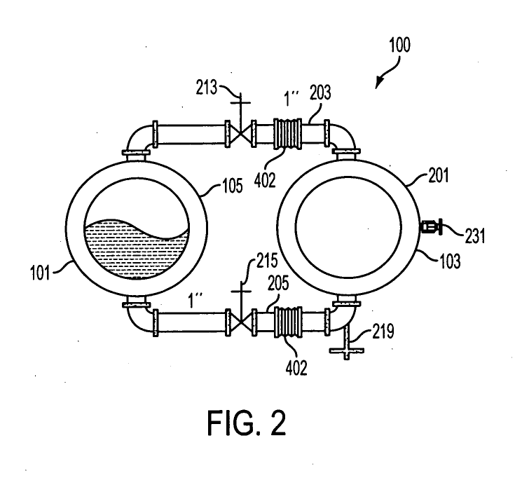

The second section (201) will generally be connected to the first section (105) by at least one flow pipe (203) or (205). In the depicted embodiment of FIGS. 1 through 3, the second section (201) is connected to the first section (105) by two flow pipes (203) and (205). The two flow pipes (203) and (205) may be any type of pipe and are, in an embodiment, arranged so as to generally be parallel in vertical alignment. In the embodiment of FIGS. 1 through 3, one flow pipe (203) connects the vertically highest points of the two sections and the other flow pipe (205) connects the vertically lowest portions. This arrangement presumes the two sections of pipe (201) and (105) are arranged horizontally and the first section (105) is placed within the main (107). This arrangement is best seen in FIG. 2.

Each of the flow pipes (203) and (205) preferably includes flow valve (213) and (215) which can be used to allow for fluid transfer between the first section (105) and second section (201) when the valves are open or, when the valves are closed, can allow the internal volume of the two pipe sections (105) and (201) to be isolated from each other. The valves (213) and (215) and flow pipes (203) and (205) combinations can allow for fluid flow (whether liquid, gas or both) to occur between the test spool (101) and the coupon rack (103). Another arrangement of flow pipes (203) and (205), where the flow pipes (203) and (205) are placed at either end of the second section (201) is shown in FIGS. 4 and 5. In this arrangement, the flow pipes (203) and (205) are preferably of similar diameter to the second section (201) and are arranged in the same horizontal plane as second section (201). This arrangement also allows for substantial duplication in conditions and may be particularly desirable in dry pipe water-based fire protection systems to eliminate any possibility of damage due to water in a flow pipe (203) or (205) freezing, expanding, and damaging the flow pipes (203) and (205).

It is generally preferred that the internal conditions within the first section (105), be duplicated as precisely as possible in the second section (201), and that the second section (201) be able to be separated from the first section (105) without disruption of the operation of the first section (105). By having the two flow valves (213) and (215) positioned within the flow pipes (203) and (205) when the valves (213) and (215) are open, a condition similar to that in the main (107) will be created within the coupon rack (103). In particular, as water is added to the water-based fire protection system, it will flow into the test spool (101) and through the flow pipe (205) and into a coupon rack (103) in the embodiment of FIGS. 1 through 3, and will flow through both flow pipes (203) and (205) in the embodiment of FIGS. 4 and 5.

Because of the location of the flow pipe (203) in the embodiment of FIGS. 1 through 3, pressure equalization will generally place the water level at the same level and pressure in both the first section (105) and the second section (201). The arrangement of FIGS. 4 and 5 will naturally have pressure equalization as both air and water flow equally through both flow pipes (203) and (205). The flow pipe (203) in the embodiment of FIGS. 1 through 3 operates in the same manner for air or any other gases (or liquid, if the liquid level is sufficiently high) and further serves to equalize the water level in the two sections (105) and (201). Therefore, when the valves (213) and (215) are open, the conditions inside the main (107) are generally substantially duplicated inside the second section (201) regardless of embodiment. Further, if the valves (213) and (215) remain open, the conditions will remain similar over time.

The coupon rack (103), as discussed above, includes various attachment points for the purposes of monitoring the conditions inside the coupon rack (103). In particular, the section can include attachment points (207) for attaching coupons, sensors, or other devices which can monitor the internal conditions of the second section (201), and/or can monitor conditions in the liquid in the second section (201). These attachment points (207) can be placed at any location around the second pipe section (201) so that they extend into the second section (201) at any angle. As shown in the FIGS, it is generally preferred that the coupons be attachable from underneath the second section (201), or from the top of the second section (201). In this way, the coupons can measure across the cross section of the liquid/gas interface if one exists, regardless of position, and can also be entirely submerged in other cases.

When used in a dry pipe water-based fire protection system the location of attachment points (207) on the lowest areas of the second section (201) is particularly beneficial. In a dry pipe water-based fire protection system there will generally not be a significant amount of water present, the attachment points (207) in the lowest portion of the second section (201) can therefore create recesses allowing water to pool or puddle at the attachment point (207). This puddling is known to occur in dry pipe water-based fire protection systems at connection points and similar points and the points of puddling are generally particularly vulnerable to corrosion or damage. The attachment points (207), by creating this artificial puddling, can therefore create a measurement point predisposed to recreate points of particular corrosion or damage risk.

The attachment points (207) will generally be holes through the outer surface of second section (201) allowing access to its internal volume. These holes will each be bordered by a connector of some form (such as screw threads) which can receive a cap or plug, which may or may not be attached to the test coupon, to be attached thereto sealing the hole. Preferably, the test coupon will hang or extend from this cap or plug a predetermined distance. It is most preferred that the test coupon be arranged so as to span any likely liquid/gas gap as that is the most likely place where corrosion can occur. In this way, the coupon will extend from the cap or plug into the internal volume of the second section (201). Preferably, the test coupon is suspended within the internal volume so as to have only minimal contact with the inner surfaces of the second section (201). It is more preferred that the test coupon only have contact with the cap or plug. It is also generally preferred that when the cap or plug is removed, the test coupon is pulled through the hole.

The test coupons will generally comprise some type of material which allows for the testing of the water, gas, or liquid/gas interface, for the presence of various compounds or activity. For instance, the test coupons may be manufactured of particular materials which chemically react with the presence of certain chemicals, particles, or microorganisms. Still further, the test coupons may provide for indications of water level or pressure or may be of a substance used elsewhere in the water-based fire protection system to test for corrosion, build-up, or damage. Test coupons are generally known to those of ordinary skill in the art, and any test coupon type may be used herein.

Generally, test coupons are considered to be of a type which need to be removed from the system in order to be checked. For instance, the test coupon may need to be removed from the pipe and tested to determine if the test coupon exhibits properties showing the presence of a particular chemical or microorganism in the water in which the coupon has been submerged. Alternatively, test coupons may be reactive in such a way that even if they can be monitored externally, they generally need to be removed and replaced after a period of time to remain effective. Some such test coupons can have electromechanical properties which depend on the presence of a particular material formed by the interaction of the coupon or probe with a particular chemical. In this case, the electromechanical properties may be monitored to detect the expected concentration of the chemical, however, if a counter-measure is added, the test coupon will generally be unable to detect if the concentration of the particular material decreases. Instead, the test coupon will need to be removed and replaced to detect the amount of the new and hopefully lower concentration.

As should be clear from the above discussion, if conditions within the coupon rack (103) are substantially duplicative of the conditions within the first section (105) and the main (107), placing the monitoring equipment within the coupon rack (103) allows for effective monitoring of the conditions which actually exist within the main (107).

While test coupons can prove very useful, they may also be supplemented by sensors which allow for instantaneous and continuous monitoring. In particular, these may be systems which are not designed to be removed from the second section (201) in order to provide indications of results. They may provide instant calculations which can then be relayed to a remote interpreter which displays the results. For instance, a thermometer could be included which monitors the instantaneous temperature inside the second section (201) at a particular point. This thermometer would not (and possibly could not) be removed to determine its reading.

To remove the test coupons in the coupon rack (103) or perform a visual inspection of the second section (201), the flow valves (213) and (215) will generally be closed to isolate the internal volume of the coupon rack (103) from the internal volume of the test spool (101) and then the coupon rack (103) is drained of liquid using drain valve (219) or a similar structure. In this way, only the liquid within the coupon rack (103) is removed leading to no loss of structural integrity of the water-based fire protection system as the draining of the coupon rack (103) does not effect the system which can continue to function uninterrupted as the first section (105) was isolated from the coupon rack (103) prior to draining. Further, due to the limited size of the coupon rack (103), the liquid within the coupon rack (103) may be drained into a bucket or similar hand portable object allowing for the coupon rack (103) to be drained by hand. Further, as a predetermined amount of liquid is drained, this liquid can also be taken for more direct testing, if desired. If the coupon rack (103) is in use in a dry pipe system, the pressure may only need to be released without any draining at all. This pressure release may occur in just the coupon rack or in the water-based fire protection system as a whole.

Once the coupon rack (103) is drained or out-of-service, the test coupons can be freely removed, examined, and/or replaced with other test coupons. In this way, test coupons can be evaluated which provide indications of corrosion or microbial activity that are present within the water-based fire protection system, while that water is still within the system as only the coupon rack (103) has been drained.

Further, once the test coupons are removed, they can be replaced with the same, similar, or different coupons which restores the structural integrity of the coupon rack and the flow valves (213) and (215) can again be opened. Since the coupon rack's (103) internal volume is generally small compared to the water-based fire protection system as a whole, the coupon rack (103) will generally be quickly returned to a state very similar to the original state it had prior to draining without a significant effect on the system as a whole. Further, the refilling of the coupon rack (103) from the water-based fire protection system, will generally not significantly change the state of the system. In particular, as the coupon rack (103) will generally be full of air (or new water) when the valves are opened. The amount of air introduced into the water-based fire protection system as a whole by the coupon rack (103) is relatively small when compared to the total volume of the system.

The inclusion of electronic or similar sensors in addition to test coupons in the coupon rack (103) can provide for two benefits over their inclusion in the main (107) even though the sensors do not generally require draining of water to utilize. Firstly, because of their placement in the coupon rack (103), the failure or damage of a sensor can allow for its replacement without the need to drain the water-based fire protection system. This can allow for quicker repair of damaged sensors. Further, the sensors can work in conjunction with sensors in the main (107) to verify that the conditions inside the coupon rack (103) are similar to those in the main (107), or in another part of the system.

In addition to coupons and sensors, the coupon rack (103) may also allow for visual inspection. It is preferred, that the coupon rack (103) include removable ends (221) and (223) which can be removed either as part of the coupon rack (103) draining operation, or after the draining operation. In this way maintenance personnel can drain the coupon rack (103), open the ends (221) and/or (223) and visually examine the interior of the coupon rack (103) without having to drain the water-based fire protection system. As the second portion (201) preferably mimics conditions within the main (107), personnel may detect the occurrence of conditions which may otherwise have not been visible in the main (107), and provide for preventative maintenance. Further, because of the size of the coupon rack (103), such visual inspection may be easier to perform.

In an embodiment, when ends (221) and (223) are removed, connectors of similar type to connectors (111) and (113) may be revealed. This could be used to make the first portion (105) and second portion (201) interchangeable for placement in main (107). As can be seen in FIGS. 4 and 5, the removable ends (221) and (223) can comprise other pipe section and, in an embodiment, all pipe connectors used in the corrosion monitoring station (100) can be the same and connectable to each other.

In a still further embodiment, the coupon rack (103) can provide for the inspection of items which may be much more difficult to view during a regular inspection. For instance, in an embodiment, the coupon rack (103) may have attached thereto sprinklers (231) which may be nonfunctional in the wet pipe water-based fire protection system or may operate (trigger) at a higher temperature than the rest of the system limiting its operation during a fire. However, after a period of time has elapsed, this sample sprinkler (231) may be examined for any corrosion by the removal from the corrosion monitoring station (100) and its replacement with another sprinkler.

Because sprinklers may include internal components which cannot be examined while they are installed, it can be difficult for maintenance personnel to determine if components may be in need of repair or replacement. In this situation, the sample sprinkler (231) can be removed and tested as necessary (even if such testing is necessarily destructive) to determine if the remaining functional sprinklers may need to be repaired or replaced.

In a still further embodiment, the corrosion monitoring station (100) can also include smaller diameter sections of pipe attached to the pipe sections (105) and (201). These smaller diameter sections are preferably of similar design and attachment to the branch lines of a water-based fire protection system. Branch lines often have air trapped within them, therefore these smaller diameter pipe sections may also include access points with associated coupons to determine if such a gas/liquid interface is present in the branch lines, and/or if there is corrosion occurring in the branch lines. A sprinkler like the above could also or alternatively be attached to the smaller diameter sections.

In another embodiment, it may be possible to separate the coupon rack (103) from the test spool (101) such as by including connectors, such as flex connectors (402), somewhere in the flow pipes (203) and/or (205) on the coupon rack (103) side of the flow valves (213) and/or (215). Flex connectors (402) can allow the coupon rack (103) to be separable from the test spool portion (101) for additional flexibility of use. The flex connectors (402) can also allow for improved positioning of coupon rack (103) allowing some adjustment of positioning to obtain the desired horizontal placement without having to rely solely on the ability of the installer to reach the desired positioning on a single attempt. In a still further embodiment, such an arrangement could be used to attach a coupon rack (103) directly to a main (107), or other pipe forming a portion of the water-based fire protection system. This embodiment eliminates the test spool portion (101) of the corrosion monitoring station (100).

In a still further embodiment, the coupon rack (103) need not only be used to detect the presence of impurities, corrosion or other dangers, but may also be used to correct them. For instance, if a material (such as a chemical counter-measure) needs to be pumped into the system based on the detection of an impurity, the pump could be attached to a drained coupon rack (103) by one of the coupon rack's (103) attachment points (207). The flow valves (203) and/or (215) are then opened which provides for access from the counter-measure pump to the main (107). The pump can therefore pump the material through the coupon rack (103) and into the main (107). Once completed, the flow valves (213) and/or (215) can be closed again, the coupon rack (103) can be drained, and the counter measure pump removed. The coupon rack (103) is then sealed again and the flow valves (213) and/or (215) are reopened allowing the coupon rack (103) to fill again with the liquid in the water-based fire protection system. In this way, the coupon rack (103) can be used, after a period of time, to monitor the effectiveness of the counter-measure which was added and determine if any additional counter measures need to be taken.

In a still further embodiment, the coupon rack (103) need not be the only component of the corrosion monitoring system (100) including test coupons. The test spool (101) may also include access points (207) and test coupons. In such an embodiment, the two sections of pipe (105) and (201) could be identical and totally interchangeable. This arrangement would allow for multiple double checks and the like to insure that the system is actively mimicking conditions in the main (107).

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A corrosion monitoring station for a water-based fire protection system comprising:
a first section of pipe, said first section replacing a portion of a water-based fire protection system and being constructed of substantially similar material to said portion it replaces;
a second section of pipe, said second section being constructed of a substantially similar material to said first section;
a first flow pipe including a first valve, said first flow pipe allowing liquid to flow from said first section to said second section when said first valve is open, and prohibiting liquid from flowing between said sections when said first valve is closed; and
a series of coupons mounted within said second section;
wherein said coupons can be removed for testing without draining said water-based fire protection system by closing said first valve, draining said second section, and removing said coupons.

2. The corrosion monitoring station of claim 1 wherein said first section and said second section are constructed of identical materials.

3. The corrosion monitoring station of claim 1 further comprising:
a second flow pipe including a second valve, said second flow pipe allowing gas to flow from said first section to said second section when said second valve is open, and prohibiting gas from flowing between said sections when said valve is closed;
wherein when said coupons are removed for testing, said second valve is also closed.

4. The corrosion monitoring station of claim 3 wherein when said first valve and said second valve are both open, the levels of liquid and gas in said first section and said second section are substantially the same.

5. The corrosion monitoring station of claim 3 wherein said first flow pipe is connected to the lowest point of said first section and said second section and said second flow pipe is connected to the highest point of said first section and said second section.

6. The corrosion monitoring station of claim 3 wherein said first and said second flow pipes are both generally in the plane of said second section of pipe.

7. The corrosion monitoring station of claim 1 wherein both said first section of pipe and said second section of pipe are arranged in generally the same horizontal plane.

8. The corrosion monitoring station of claim 1 wherein said portion of said water-based fire protection system replaced by said first section comprises a portion of a main.

9. The corrosion monitoring station of claim 1 wherein said portion of said water-based fire protection system replaced by said first section comprises a portion of a branch line.

10. The corrosion monitoring station of claim 1 wherein said first section also includes a series of coupons therein.

11. The corrosion monitoring station of claim 1 wherein said first section also includes two couplings for removably attaching said first section to said water-based fire protection system.

12. The corrosion monitoring station of claim 11 wherein said second section includes similar couplings to said first section.

13. The corrosion monitoring station of claim 1 wherein at least one of said first section and said second section includes a sprinkler.

14. The corrosion monitoring station of claim 1 wherein at least one of said first section and said second section includes an electronic probe.

15. The corrosion monitoring station of claim 1 wherein said water-based fire protection system comprises a wet pipe water-based fire protection system.

16. The corrosion monitoring station of claim 1 wherein said water-based fire protection system comprises a dry pipe water-based fire protection system.
